(19) United States
(12) Patent Application Publication
(10) Pub. No.: US 2014/0089056 A1
(43) Pub. Date: Mar. 27, 2014

(54) ESTIMATION OF EFFECTS OF PROCESS CUSTOMIZATION

(71) Applicant: International Business Machines Corporation, Armonk, NY (US)

(72) Inventors: Rama K.T. Akkiraju, Cupertino, CA (US); Pietro Mazzoleni, New York, NY (US); Aubrey J. Rembert, Chappaqua, NY (US)

(73) Assignee: INTERNATIONAL BUSINESS MACHINES CORPORATION, Armonk, NY (US)

(21) Appl. No.: 13/974,364

(22) Filed: Aug. 23, 2013

Related U.S. Application Data
(62) Division of application No. 13/617,676, filed on Sep. 14, 2012.
Application No. 13/617,676 is a continuation of application No. 13/596,869, filed on Aug. 28, 2012.

(51) Int. Cl. G06Q 10/06

(52) U.S. Cl. CPC G06Q 10/0637
USPC 705/7.36

(57) ABSTRACT

Embodiments include a method of estimating effects of modifications to a process. The method includes determining, by a processor, first differences between a graphical representation of a first modified process and a base process having been modified by the first modified process. The method also includes comparing, by the processor, the first differences with second differences between a graphical representation of at least one second modified process and the base process. The method also includes estimating a first effect of the first differences relative to the base process based on a similarity between the first differences and the second differences and based on at least one second effect of the second differences relative to the base process, the second effect stored and associated with the second differences in memory.

### CROSS-REFERENCE TO RELATED APPLICATIONS AND PRIORITY CLAIM

This application is a divisional of U.S. Non-Provisional application Ser. No. 13/617,676, filed Sep. 14, 2012, which is a continuation of U.S. Non-Provisional application Ser. No. 13/596,869, filed Aug. 28, 2012 which is incorporated herein by reference in its entirety.

### BACKGROUND

The present disclosure relates to estimating the effects of customizing processes, and in particular to comparing a modified process to processes stored in memory to estimate the effects of the modified process based on the effects of the processes stored in memory.

Standardizing processes, such as business processes, may provide benefits of providing predictable processes, resulting in predictable costs, predictable timelines for completing processes, reduced unexpected or unplanned events, etc. However, standardized processes lack flexibility and may result in lost revenues, inefficient use of time or resources, and inability to adapt to unforeseen or unplanned circumstances. As a result, users, organizations, or systems may desire customized processes to adjust to particular circumstances.

When users, organizations, or systems modify standardized processes, it may be unclear what the effects of the modifications may be. For example, a user may modify a process with a goal to increase revenue generated by the process, but the user may not be aware of temporal effects of the modifications on the process.

### SUMMARY

Exemplary embodiments include a method of estimating effects of modifications to a process. The method includes determining, by a processor, first differences between a graphical representation of a first modified process and a base process having been modified by the first modified process. The method also includes comparing, by the processor, the first differences with second differences between a graphical representation of at least one second modified process and the base process. The method also includes estimating a first effect of the first differences relative to the base process based on a similarity between the first differences and the second differences and based on at least one second effect of the second differences relative to the base process, the second effect stored and associated with the second differences in memory.

Additional exemplary embodiments include a method for suggesting modifications to a process. The method includes receiving, by a processor, a base process and at least one desired effect. The method also includes comparing, by the processor, the at least one desired effect to one or more effects stored in memory, the one or more effects associated with one or more stored modified processes being stored in a modified process repository. The method also includes suggesting, by the processor, at least one of the one or more stored modified processes based on a similarity of the one or more effects to the at least one desired effect and based on a similarity of the one or more stored modified processes to the base process.

Additional features and advantages are realized through the techniques of the present disclosure. Other embodiments and aspects of the present disclosure are described in detail herein and are considered a part of the claimed disclosure. For a better understanding of the disclosure with the advantages and the features, refer to the description and to the drawings.

### BRIEF DESCRIPTION OF THE SEVERAL VIEWS OF THE DRAWINGS

The subject matter of the disclosure is particularly pointed out and distinctly claimed in the claims at the conclusion of the specification. The forgoing and other features, and advantages of the disclosure are apparent from the following detailed description taken in conjunction with the accompanying drawings in which:

FIG. 1 illustrates a system for estimating effects of processes according to one embodiment of the present disclosure;

FIG. 2 illustrates a flowchart of a method of populating repositories according to one embodiment;

FIG. 3 illustrates a flowchart of a method of estimating effects of a process modification according to one embodiment;

FIG. 4 illustrates a flowchart for suggesting a modified process according to one embodiment;

FIGS. 5A to 5D illustrate process diagrams according to one embodiment;

FIG. 5A illustrates an example of a base process;

FIG. 5B illustrates an example of a modified process;

FIG. 5C illustrates an example of determining differences between a base process and a modified process;

FIG. 5D illustrates a comparison of differences between two modified processes;

FIG. 6 illustrates a computer system according to one embodiment; and

FIG. 7 illustrates a computer program product according to one embodiment.

### DETAILED DESCRIPTION

Modifying standardized processes may have unknown, unclear, or unintended consequences. Embodiments of the present disclosure relate to providing estimates of effects of modifications to a base process by analyzing the effects of previously-modified processes stored in memory.

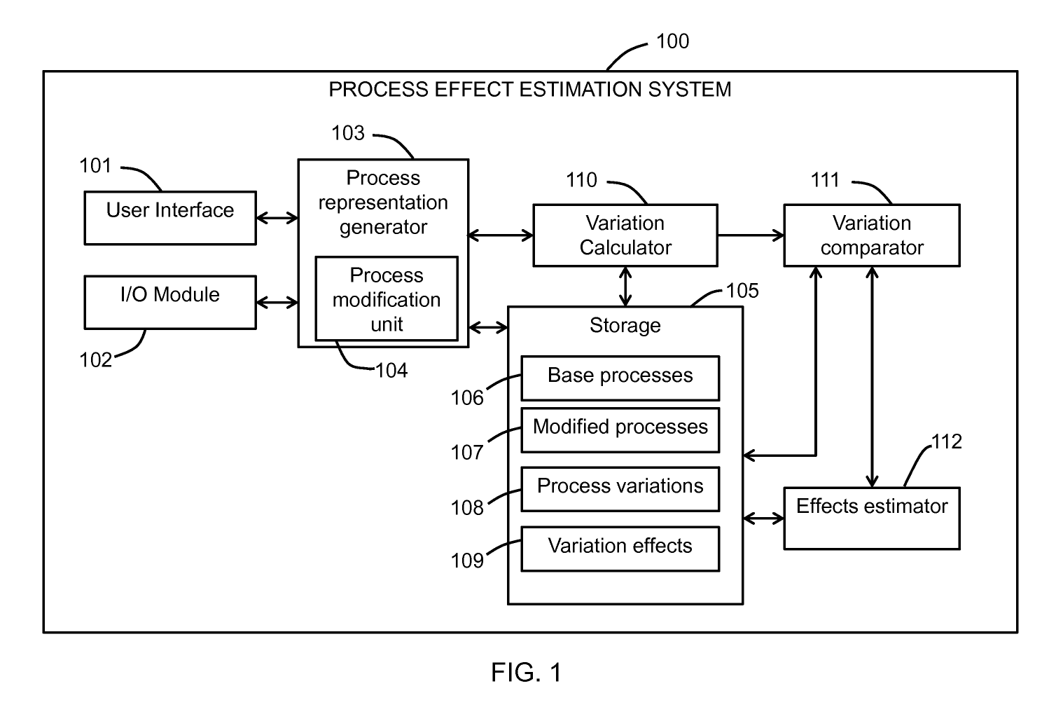

FIG. 1 illustrates a process effect estimation system 100 according to one embodiment of the present disclosure. The system 100 includes one or both of a user interface 101 and an input/output (I/O) module 102. The system 100 may include a process representation generator 103 configured to generate a graphical representation of a process based on stored data, data input from a user via the user interface 101 or data from another system or device via the I/O module 102. In example embodiments, the user interface 101 may include tactile inputs such as a keyboard, mouse, touchscreen or any other input configured to be acted upon by a user to generate data. In addition, the I/O module 102 may include data ports, antenna or any other mechanisms to receive data from other systems or devices.

In one embodiment, the graphical representation of a process includes one or more nodes interconnected by lines or other connectors to indicate a relationship between one node and another. The one or more nodes may represent steps, actions, selections, choices, alternatives, sub-processes or any other component of a process. The nodes may include, or be associated with, semantic data that describes the purpose of the node (e.g., the step or action represented by the node). The processes may be stored in electrical memory as data which, when displayed by a display device, appears as interconnected blocks, polygonal shapes, or any other representation of interconnected nodes. The semantic data may be stored as data that is associated with a corresponding node and may be displayed inside the node, alongside the node, in the vicinity of the node, or in charts separate from the node, or, alternatively, the semantic data may not be displayed with the node. The graphical representations of the processes may be in a tree format, such as a hierarchal tree, a Process Structure Tree (PST), Petrinet models, or any other type of tree format.

The system 100 further includes memory or storage 105. The storage 105 may include volatile memory and non-volatile memory. In other words, in the present specification and claims, the terms memory, storage, storage device, etc. may refer to any type of memory or storage device, including flash memory devices, hard disks, magnetic storage disks, optical disks, etc. In one embodiment, the storage 105 includes one or more databases or repositories of organized data corresponding to processes. The storage 105 may include a base processes repository 106 configured to store one or more predefined base processes. The data stored in the base processes repository 106 may include graphical representations of the base processes, or data that, when displayed by a display apparatus, illustrates the graphical representations of the base processes. The base processes may correspond to standardized processes of one or more users, devices, organizations or any other person, group, system or machine that operates based on a process.

The storage 105 further includes a modified process repository 107, a process variation repository 108 and a variation effects repository 109. The modified process repository 107 may store modified processes associated with the base processes stored in the base process repository 106. The process variations repository 108 includes data corresponding to differences between the modified processes of the modified process repository 107 and base processes of the base process repository 106. In other words, while the modified process repository 107 may store data corresponding to an entire modified process, the process variations repository 108 may store data directed only to the modified portions of the modified process. In addition, in one embodiment the process variations repository 108 may store data related only to nodes of a graphical representation of a process associated with some measurable effect. In such an embodiment, changes to a base process that have no measurable effect may be ignored when analyzing a newly-modified process. The variation effects repository 109 includes data regarding the effects of the variations on processes.

For example, if a base process XX is defined by sequential steps A, B and C, and if a modified process XY is defined by sequential steps A, B and D, then data corresponding to the difference between the base process and the modified process may be stored in the process variations repository 108. For example, the process variations repository 108 may store data similar to the following: XY: [XX, −C, +D], where XY describes the modified process, XX describes the base process, and −C and +D describe nodes that are omitted from, and added to, the base process, respectively. The foregoing example is provided as a simple example only, and it is understood that the process variations repository 108 may store data corresponding to a graphical representation of a process, such as a structural location of deleted and added nodes within a process, dependencies of, or dependencies from, modified nodes, semantic information such as node descriptions, or any other information regarding a process difference.

The variation effects repository 109 may store any information regarding the effects of variations to the base processes. The information regarding the effects of variations may be measured or observed data, predicted data, calculated data, or any other measurable data. For example, if ten organizations or systems have implemented a modification corresponding to the variation XY, then the effects observed or measured by the ten organizations or systems may be stored in the variation effects repository 109. If organizations or systems have determined that, on average, implementing the variation XY results in a temporal change in the process, such as a reduced time to complete the process, the information regarding the temporal change may be stored in the variation effects repository. The information may be stored separately, aggregated, averaged or otherwise combined to be stored. Other variation effects that may be stored include changes in revenue, cost, time to implement or repeat, likelihood of performing a particular action or executing a particular node of a process, or any other measurable technical or financial effects.

The effects of the repository 109 may be associated with the differences of the modified processes in memory, such as by displaying the effects together with nodes of the modified processes in a graphical representation of the modified processes, or by any other means.

In one embodiment, base processes, modified processes, process variations and variation effects may be stored and organized in categories of industry, scenario, business objectives, business objectives affected, performance objectives affected, or any other type of organization of data into categories, which may be browsable by a user or system. In such an embodiment, a user or system may search the repositories 106, 107, 108 and 109 for desired processes, modifications, variations or effects based on the predefined categories or upon customized categories generated by a user.

The process representation generator 103 may access a base process from the base processes repository 106 and may generate a modified process with the process modification unit 104 based on data received from one or more of the user interface 101 and the I/O module 102. Alternatively, the process representation generator 103 may generate a graphical representation of a process based solely upon the input from the user interface 101 or I/O module 102 without reference to the base processes repository 106. A user may modify a process by interacting with a graphical user interface (GUI) displaying the graphical representation of the process, via a text-based interface, such as programming code, or via any other type of interface

A variation calculator 110 may determine a variation, or a difference, of the modified process from a base process stored in the base processes repository 106. The variation corresponds to the difference between the modified process and the base process. In other words, an output from the variation calculator may identify the variations in a modified process from a base process. The identification may be a graphical annotation, a semantic annotation associated with particular nodes of a process or any other form of identification. In one embodiment, the variation calculator 110 may calculate differences between a standard representation of a process and a modified process by utilizing one or more of tree-matching, schema-matching, and structure-matching techniques.

In some embodiments, the modified process is generated by the process modification unit 104. However, in some embodiments, the modified process is provided directly via the user interface 101 or the I/O module 102 without being generated by the process representation generator 103. In other words, in some embodiments, the process representation generator 103 may be located external to the process effect estimation system 100.

In an embodiment in which a modified process is provided from an external source, such directly from a user interface 101 or the I/O module 102, the variation calculator 110 may access the base process repository 106 to determine which base process stored in the repository 106 most closely resembles the modified process. Then, the variation calculator 110 may calculate the variations of the modified process from the base process.

A variation comparator 111 may compare the calculated variation or difference from the variation calculator 110 with stored variations in the process variation repository 108. The variation comparator 111 may compare the variations by comparing structures of a graphical representation of the variations, such as a similarity in locations and configurations of nodes and node connectors. The variation comparator 111 may also compare the variations by comparing semantic content of nodes and node connectors. Semantic content may include, for example, tags, labels, names, descriptors and values used to describe the nodes and node connectors, such as a description of an action performed at the node when executing the process.

In one embodiment, the variation comparator 111 may generate a list of process variations stored in the process variation repository 108 that most closely resemble the variation calculated by the variation calculator 110. The list may rank the variations according to their similarity to the calculated variation. The similarities may be structural, semantic or any other type of measurable similarity.

In one embodiment, the variation comparator 111 compares data corresponding to nodes of a modified process, output from the variation calculator 110, with only data corresponding to nodes of stored modified processes having effects associated with the nodes. In other words, the process variations of the process variations repository 108 include data corresponding to graphical representations of nodes of modified processes. Some of the nodes may be associated with effects in the variation effects repository 109, while other nodes may be associated with no effects in the variation effects repository 109. In one embodiment, the variation comparator 111 compares the data from the variation calculator 110 only with the data corresponding to nodes of the process variations repository 108 that are associated with effects in the variation effects repository 109, thereby reducing processing demands of the system and increasing the efficiency of the analysis.

An effects estimator 112 estimates the effects associated with the received modification to the base process based on the effects stored in the variation effects repository 109 associated with the process variations in the process variations repository 108. For example, if the variation comparator 111 determines that three process variations, or differences between a previously-modified process and a base process, most closely resemble the calculated variations output by the variation calculator 110 based on the presently-received modification to the base process, the effects estimator 112 may access the variation effects repository 109 and may retrieve the stored effects corresponding to the three most closely-related variations. In one embodiment, a user or system may view a plurality of possible effects ranked according to the similarity of the corresponding process variations to the presently-calculated process variations. In another embodiment, the effects corresponding to the most closely-related variations may be combined, such as by averaging values, and the combined effects may be provided to the user as an estimate of effects of the presently-modified process.

According to the above-described embodiment, a user or system may provide a modified process to a standard process, and the effects estimator 112 may provide to the user or system estimated effects of the modifications based on stored effects of the same or similar modifications. The data for the base processes, modified processes, variations and effects may be based on actual observed or measured processes, variations and effects, or may be based on pre-defined processes, variations and effects. For example, an organization may provide or implement business processes in itself or for other entities, and may observe and record effects of the implementations of the business processes in the entities. The processes, including base processes and modifications, may be recorded, and the effects of changes to the base processes may also be recorded. The recorded processes and effects may comprise the repositories 106, 107, 108 and 109 of the above-described embodiment. Consequently, when a next entity requests a particular change to a standard process, the organization may provide to the entity an estimate of the effects of the change based on previously observed and measured effects of the same or similar changes in other entities.

In addition, embodiments of the present disclosure encompass generating a modified process based on a standard or base process and desired effects. For example, an entity may have a standard process which may be stored in the base processes repository 106 and may provide to the process effect estimation system a list of one or more desired effects. The effects estimator 112 may receive as an input the desired effects, may search the variation effects repository 109 for a similar grouping of effects, may determine corresponding variations in the process variations repository 108, and may identify one or more modified processes in the modified process repository 107 corresponding to the desired effects. The one or more modified processes may be provided to the entity via the user interface 101 or I/O module 102. The one or more modified processes may be ranked based on a similarity of the stored variation effects with the desired effects provided by the entity.

Accordingly, a user, system or other entity may receive suggestions for modifying a process based on measured or observed effects. For example, the user may utilize a base process and may request an effect of reducing an execution time of the process while ensuring that a new action P is performed. The effects estimator 112 may search the variation effects repository 109 for the effect of reducing execution time, and the variation comparator 111 may narrow the results to modified processes including a node for performing the action P. One or more resulting modified processes may be provided to the user that are based on the same base process as that provided by the user, or the most similar modified processes may be provided to the user.

According to embodiments of the present disclosure, the process effect estimation system 100 may provide estimates of effects of modification to processes in response to receiving as an input data corresponding to modifying a process. Alternatively, the system 100 may receive as an input desired effects and a base process and may provide one or more suggested modified processes. The processes and effects stored in the system 100 may be based on real-life implementations of processes and measured or observed effects. Accordingly, an entity requesting estimated effects or suggested modified processes may receive estimations or suggestions based on repositories of real-life data.

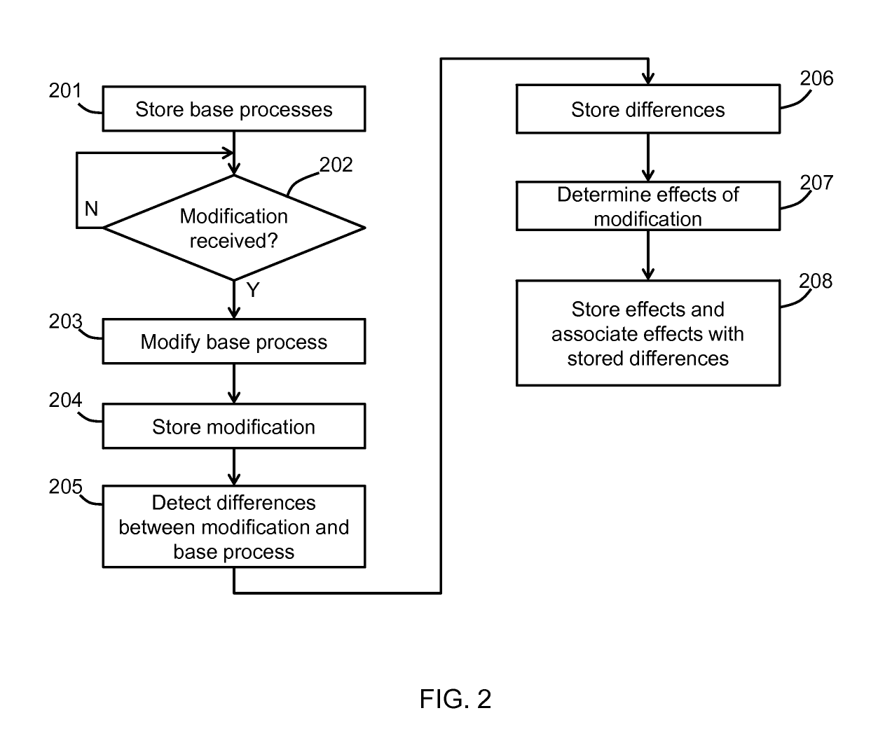

FIG. 2 illustrates a flowchart of a method of populating repositories according to one embodiment of the present disclosure. In block 201, a base process is stored in a repository. The base process may be stored as data that, when provided to a processing unit, generates a graphical representation of a process, such as a flowchart, tree diagram, or any other graphical representation of the process. The graphical representation may include nodes and connectors, where each node represents an action of the process and the connectors represent a flow of the process between the nodes. The base process may include semantic data including descriptions of purposes and characteristics of nodes.

In decision block 202, it is determined whether a modification is received or generated. If so, in block 203 the base process is modified, and in block 204 the modifications are stored. The modification may include the addition or deletion of one or more nodes of the base process, or the modification of semantic data corresponding to one or more nodes of the base process. In block 205, differences or variations between the base process and the modified process are determined and stored in block 206. The differences may be stored by associating identifying metadata, graphical data, or other semantic data with the nodes corresponding to the differences. For example, if a base process includes three nodes and a modified process includes one additional node, the additional node is recognized as a difference from the base process and data is stored and associated with the additional node to identify the additional node as a difference from the base process.

The differences may be determined by analyzing a structure of the graphical representation of the first modified process and the base process, semantics associated with nodes of the first modified process and the base process, or any other observable and quantifiable criteria.

In block 207, effects of the modifications to the base process may be determined. The effects may be measured, observed or calculated. For example, a real-life entity may provide data regarding effects and consequences of a real-life implementation of the modified process. Data regarding the effects of the modification may be stored in block 208 and may be updated as new effects data is provided. The effects are associated in memory with the corresponding modified process, and in particular to the stored differences between the modified processes and the base processes. In embodiments of the present disclosure, the effects are defined as the effects of changing the modified process with respect to the base process. Accordingly, effects may not correspond to nodes that are in common between the base process and the modified, but rather the effects may correspond only to the nodes that are different from the base process. For example, in the example above in which one node is added to a base process, the effects of the added node may be identified and stored, while, for the purposes of analyzing the effects of changes to the base process, the remaining effects of the modified process may be ignored.

Accordingly, a repository may be generated including one or more base processes, one or more modifications to the base processes, one or more differences between the modifications and the base processes, and one or more effects associated with the differences.

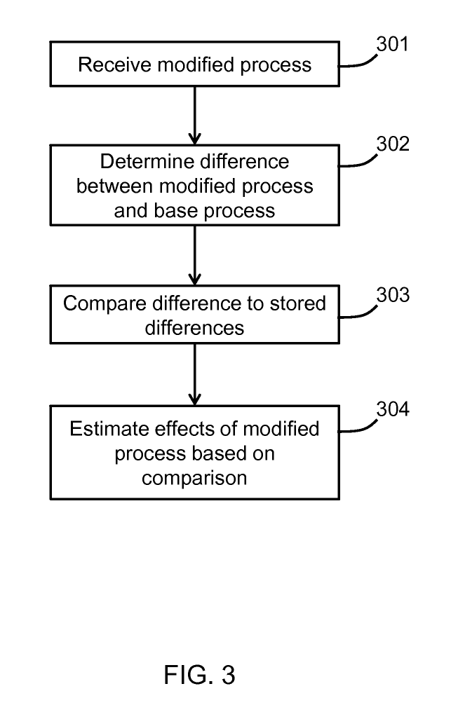

FIG. 3 illustrates a process for estimating effects of modifications to a base process according to one embodiment. In block 301, a modification to a base process is received. For example, a user or system may provide data to the system including the repositories of process and effects data indicating a desired modification to the base process. In block 302, differences between the modified process and the base process are calculated. The differences may be determined by analyzing a structure of the graphical representation of the modified process and the base process, semantics associated with nodes of the modified process and the base process, or any other observable and quantifiable criteria.

In block 303, the differences between the modified process and the base process are compared to the differences between stored modified processes and the base process. In embodiments of the present disclosure, comparing the differences instead of comparing entire modified processes may result in improved efficiency by omitting from analysis nodes of the processes that would have no measurable or observable effects on the modification of the base process. Comparing the differences may include comparing semantics and structural characteristics of nodes represented in the differences. For example the differences may be data that, when displayed, correspond to graphical representations of nodes of the processes, and comparing the differences may correspond to comparing the structures of the nodes or the semantics of the nodes.

In block 304, effects of the modified process may be estimated based on the comparison of block 303 and based on stored effects associated with the stored modified processes. In particular, a closeness or similarity between the differences of the modified process and stored differences may be determined, and effects associated with the most similar stored differences may be provided as estimates for effects of the modified process received in block 301.

In one embodiment, estimated effects may be extrapolated based on the stored effects and the comparison of block 303. In some embodiments, the stored effects may be provided as ranked effects based on the similarity between corresponding stored differences and the differences of the modified process. In such an embodiment, effects may be numerically or graphically presented to indicate that effects corresponding to a more-similar modification stored in a repository may be more likely to occur than effects that correspond to a less-similar modification stored in the repository.

Accordingly, one or more modifications to a base process stored in memory may be analyzed to provide estimated effects of a subsequent modification to the base process.

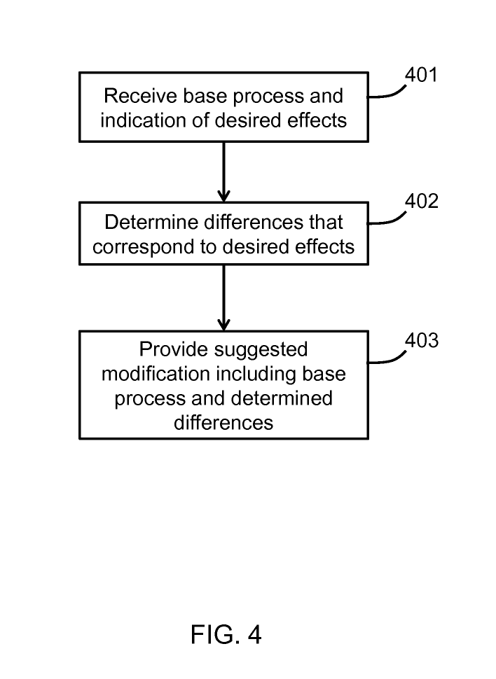

FIG. 4 illustrates a method of providing suggested modifications to a base process according to an embodiment of the present disclosure. In block 401, data regarding a base process and desired effects may be received. For example, a user or system that presently practices a base process may be searching for suggestions for modifying one or more metrics, such as productivity or revenue, or reducing time to achieve a result.

In block 402, differences may be determined that correspond to the desired effects. In embodiments of the present disclosure, “differences” correspond to differences or variations between a modified process and a base process. In a repository according to embodiments of the present disclosure, effects are associated with stored differences based on previous modifications to the base process. For example, the previous modifications may be modifications made by one or more entities to the base process, and the one or more entities may observe and record effects resulting from the modifications to the base process. In one embodiment, one or more differences may be determined based on a closeness of the effects associated with the differences with the desired effects indicated in block 401.

In block 403, one or more suggested modifications to the base process may be provided based on the determinations of block 402. For example, if it is determined that three stored sets of effects are most similar to the desired effects provided in block 401, the three associated modified processes may be provided as suggestions to the entity that provided the desired effects.

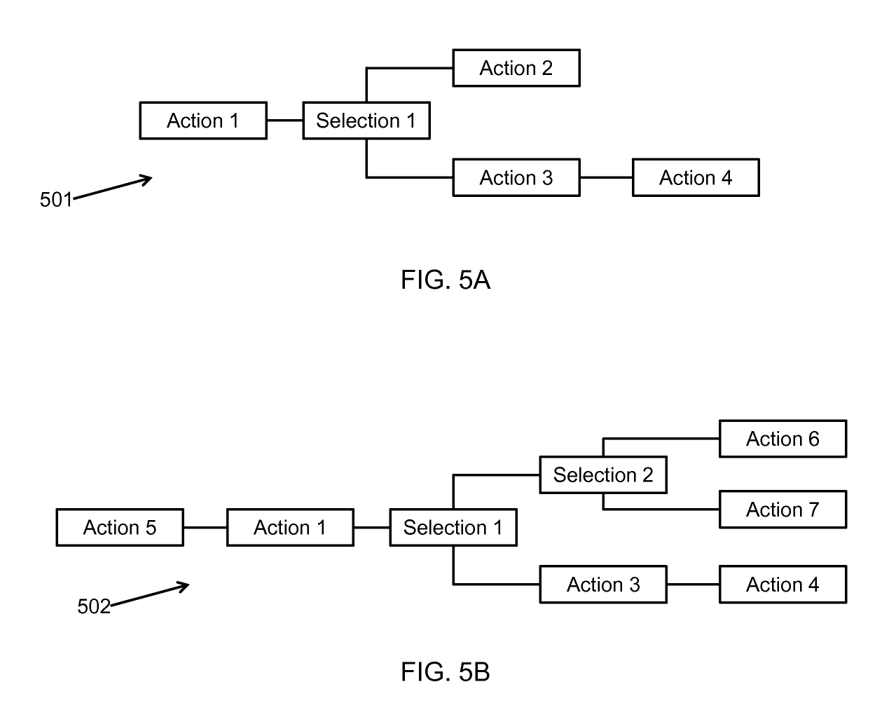

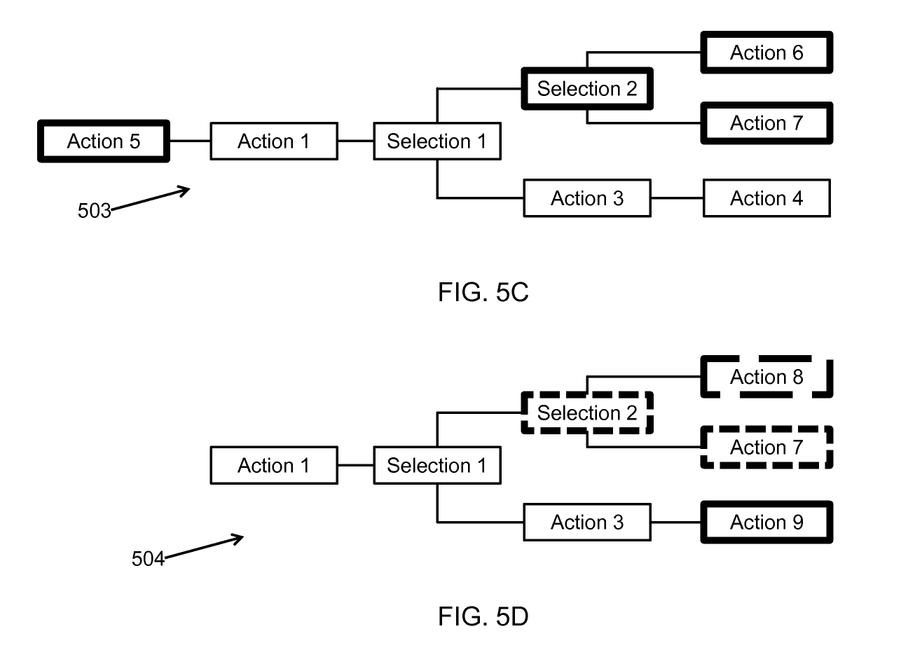

FIGS. 5A to 5D illustrate examples of graphical representations of processed according to one embodiment. FIG. 5A illustrates a base process 501. The base process includes a plurality of nodes, each representing a step, operation or stage of the process. The base process 501 includes actions, such as Action 1, Action 2, Action 3, and Action 4. A base process also may also include one or more selections or branches. For example, the base process 501 includes one selection or branch, Selection 1.

FIG. 5B illustrates a modified process 502 corresponding to the base process of FIG. 5A. The modified process may include one or more nodes that are different from the nodes of the base process, or may have a structure different from that of the base process. For example, the modified process 502 of FIG. 5B includes Action 5, Selection 2, Action 6 and Action 7.

FIG. 5C illustrates a graphical representation 503 of a determination of differences between the modified process of FIG. 5B and the base process of FIG. 5A. In FIG. 5C, Action 5, Selection 2, Action 6 and Action 7 are highlighted and are determined to be the differences between the base process of FIG. 5A and the modified process of FIG. 5B. In embodiments of the present disclosure, the differences may be identified or designated in memory by associating metadata, graphical representations, or other semantic data with the differences to distinguish the differences from other nodes that overlap the base process. Then, effects of modifications to a base process may be estimated by referring only to the designated differences rather than to each node of a modified process.

In embodiments of the present disclosure, effects may be stored and associated with the respective nodes that define differences between the modified process 503 and the base process 501. For example, effect data, such as “[type A; degree +1]” may be associated with the node Action 5 indicating that an effect of a type A (such as “revenue”, “cost”, “time to complete”, etc.) is caused by performance of the action indicated by the node Action 5, and the node causes the effect by a degree of +1 (such as 1 financial unit, 1 unit of time, etc.). Similar data may be associated with each node Selection 2, Action 6, and Action 7, and cumulative data may be associated with the entire process 503.

FIG. 5D illustrates a second modified process 504 and a comparison of the differences between the modified processes and the base process. In embodiments of the present disclosure, one of the modified processes 502 and 504 may be stored in memory and the other may be provided by a system or user. The graphical representation of the modified process 504 illustrates four nodes (Selection 2, Action 7, Action 8, and Action 9) that are different from the base process 501. In one embodiment, metadata or other semantic data associated with the modified process 504 may indicate that the node Selection 2 of the modified process 504 is structurally in the same location as the node Action 2 of the base process 501, and that the node Action 9 of the modified process 504 is structurally in the same location as the node Action 4 of the base process 501.

In addition, the modified process 504 graphically indicates nodes, such as Selection 2 and Action 7, are the same as the modified process 503. In addition, the modified process 504 indicates a node Action 8 that is structurally the same as node Action 6 of the modified process 503, but semantically different. In embodiments of the present disclosure, the similarities between the modified processes 502 and 504, and in particular, the similarities in the differences between the modified process 502 and the base process 501 and the modified process 504 and the base process 501 may be identified, categorized, and ranked based on a level of similarity. For example, the node Action 7 of modified processes 502 and 504 may be ranked with a high level of similarity, since the semantic content and structure of the node are the same in both modified processes 502 and 504. In contrast, the node Action 6 of the modified process 502 may be designated with a lower level of similarity to the node Action 8 of the modified process 504, since the two nodes share a structural position but have different semantic content.

While examples of a base process, modified processes, identified differences between the processes, and comparisons between the differences have been illustrated with blocks and lines to represent nodes of a graphical representation of a process, embodiments of the present disclosure encompass any manner of representing processes and representing semantic content associated with nodes of a process, including representing actions or selections, representing variations of a modified process from a base process, representing effects associated with nodes that correspond to variations from a base process, or representing any other data associated with the process.

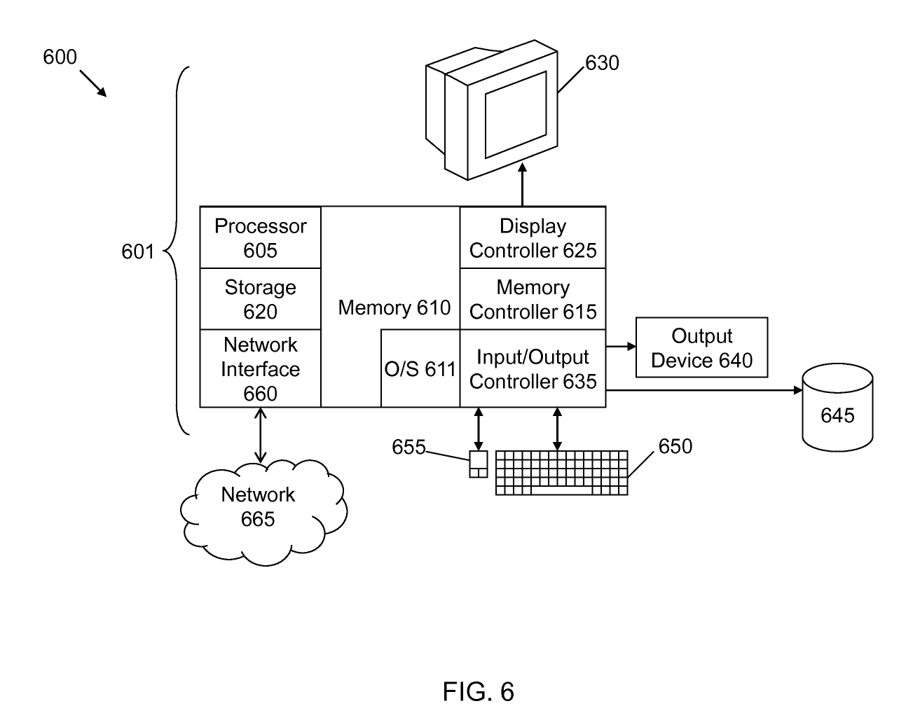

FIG. 6 illustrates a block diagram of a computer system 600 according to an embodiment of the present disclosure. The methods described herein can be implemented in hardware, software (e.g., firmware), or a combination thereof. In an exemplary embodiment, the methods described herein are implemented in hardware as part of the microprocessor of a special or general-purpose digital computer, such as a personal computer, workstation, minicomputer, or mainframe computer. The system 600 therefore may include general-purpose computer or mainframe 601.

In an exemplary embodiment, in terms of hardware architecture, as shown in FIG. 6, the computer 601 includes a one or more processors 605, memory 610 coupled to a memory controller 615, and one or more input and/or output (I/O) devices 640, 645 (or peripherals) that are communicatively coupled via a local input/output controller 635. The input/output controller 635 can be, for example, one or more buses or other wired or wireless connections, as is known in the art. The input/output controller 635 may have additional elements, which are omitted for simplicity in description, such as controllers, buffers (caches), drivers, repeaters, and receivers, to enable communications. Further, the local interface may include address, control, and/or data connections to enable appropriate communications among the aforementioned components. The input/output controller 635 may access the output devices 640 and 645.

The processor 605 is a hardware device for executing software, particularly that stored in storage 620, such as cache storage, or memory 610. The processor 605 can be any custom made or commercially available processor, a central processing unit (CPU), an auxiliary processor among several processors associated with the computer 601, a semiconductor based microprocessor (in the form of a microchip or chip set), a macroprocessor, or generally any device for executing instructions.

The memory 610 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 610 may incorporate electronic, magnetic, optical, and/or other types of storage media. Note that the memory 610 can have a distributed architecture, where various components are situated remote from one another, but can be accessed by the processor 605.

The instructions in memory 610 may include one or more separate programs, each of which comprises an ordered listing of executable instructions for implementing logical functions. In the example of FIG. 6, the instructions in the memory 610 include a suitable operating system (O/S) 611. The operating system 611 essentially controls the execution of other computer programs and provides scheduling, input-output control, file and data management, memory management, and communication control and related services.

In an exemplary embodiment, a conventional keyboard 650 and mouse 655 can be coupled to the input/output controller 635. Other output devices such as the I/O devices 640, 645 may include input devices, for example, but not limited to a printer, a scanner, microphone, and the like. Finally, the I/O devices 640, 645 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 600 can further include a display controller 625 coupled to a display 630. In an exemplary embodiment, the system 600 can further include a network interface 660 for coupling to a network 665. The network 665 can be any type of network, such as an IP-based network for communication between the computer 601 and any external server, client and the like via a broadband connection, an optical fiber network, or any other type of network.

The network 665 transmits and receives data between the computer 601 and external systems. In an exemplary embodiment, network 665 can be a managed IP network administered by a service provider. The network 665 may be implemented in a wireless fashion, e.g., using wireless protocols and technologies, such as WiFi, WiMax, etc. The network 665 can also be a packet-switched network such as a local area network, wide area network, metropolitan area network, Internet network, or other similar type of network environment. The network 665 may be a fixed wireless network, a wireless local area network (LAN), a wireless wide area network (WAN) a personal area network (PAN), a virtual private network (VPN), intranet or other suitable network system and includes equipment for receiving and transmitting signals.

When the computer 601 is in operation, the processor 605 is configured to execute instructions stored within the memory 610, to communicate data to and from the memory 610, and to generally control operations of the computer 601 pursuant to the instructions.

In an exemplary embodiment, the methods of managing memory described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In embodiments of the present disclosure, the process effect estimation system may utilize hardware and software within the computer system 600, including memory 610 or output devices 640 and 645 for storing process data in repositories, the processor 605 for analyzing process data, the display controller 625 for converting stored data into data for displaying graphical representations of the process data, the display 630 for displaying the process data, and the keyboard 650 and mouse 655 for receiving user input regarding processes and effects.

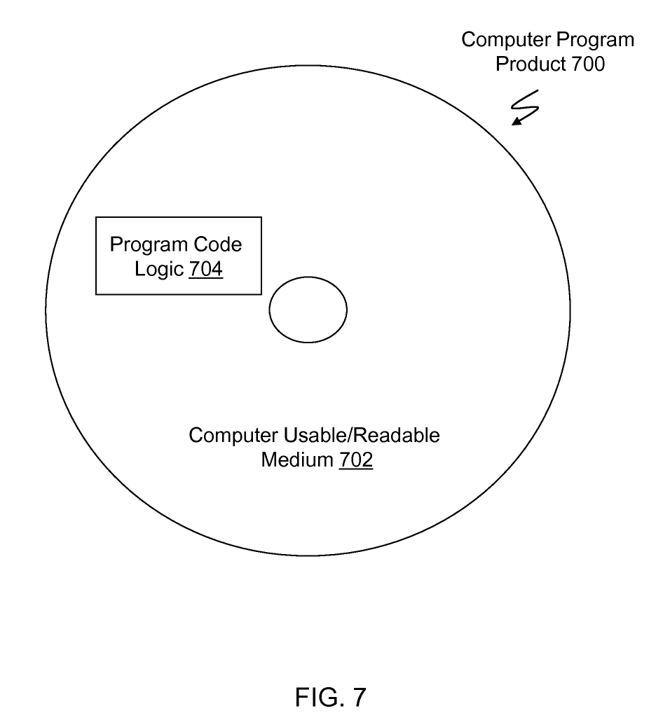

As described above, embodiments can be embodied in the form of computer-implemented processes and apparatuses for practicing those processes. An embodiment may include a computer program product 700 as depicted in FIG. 7 on a computer readable/usable medium 702 with computer program code logic 704 containing instructions embodied in tangible media as an article of manufacture. Exemplary articles of manufacture for computer readable/usable medium 702 may include floppy diskettes, CD-ROMs, hard drives, universal serial bus (USB) flash drives, or any other computer-readable storage medium, wherein, when the computer program code logic 704 is loaded into and executed by a computer, the computer becomes an apparatus for practicing the embodiments. Embodiments include computer program code logic 704, for example, whether stored in a storage medium, loaded into and/or executed by a computer, or transmitted over some transmission medium, such as over electrical wiring or cabling, through fiber optics, or via electromagnetic radiation, wherein, when the computer program code logic 704 is loaded into and executed by a computer, the computer becomes an apparatus for practicing the embodiments. When implemented on a general-purpose microprocessor, the computer program code logic 704 segments configure the microprocessor to create specific logic circuits.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention to the particular embodiments described. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosed embodiments. Many modifications and variations will be apparent to those of ordinary skill in the art without departing from the scope and spirit of the embodiments of the present disclosure.

In embodiments of the present disclosure, effects of modifications to standard business processes may be estimated based on stored prior modifications to the standard business processes. In addition, proposed modifications to standard business processes may be provided based on desired effects provided by an entity. Accordingly, past customizations to processes may be utilized to more efficiently design and select future customizations. In addition, guidance may be provided to entities regarding the likely effects of desired changes to processes implemented by the entities. Examples of processes may include business financial or operational processes, software or electrical processes and manufacturing processes. However, it is understood that embodiments of the present disclosure encompass any process that may be represented by data in a graphical form, stored and analyzed.

While preferred embodiments have been described above, it will be understood that those skilled in the art, both now and in the future, may make various improvements and enhancements which fall within the scope of the claims which follow.

What is claimed is:

1. A method for suggesting modifications to a process, comprising:
receiving, by a processor, a base process and at least one desired effect;
comparing, by the processor, the at least one desired effect to one or more effects stored in memory, the one or more effects associated with one or more stored modified processes being stored in a modified process repository; and
suggesting, by the processor, at least one of the one or more stored modified processes based on a similarity of the one or more effects to the at least one desired effect, and based on a similarity of the one or more stored modified processes to the base process.

2. The method of claim 1, wherein the desired effect includes one or more of a financial effect, a temporal effect, and a measure of complexity.

3. The method of claim 1, further comprising:
comparing the base process to one or more stored base processes,
wherein the one or more modified processes suggested by the processor modify the one or more stored base processes that most closely resemble the base process.

4. The method of claim 3, wherein comparing the base process to the one or more stored base processes includes comparing a graphical representation of a structure of the base process with a graphical representation a structure of the one or more stored base processes.

5. The method of claim 4, wherein the graphical representations of the structure of the base process and the one or more stored base processes include a plurality of nodes representing steps performed to execute the processes.

6. The method of claim 3, wherein comparing the base process to the one or more stored base processes includes comparing semantic characteristics of the base process with semantic characteristics of the one or more stored base processes.

7. The method of claim 1, wherein the one or more stored modified processes are stored as data that, when displayed, displays a graphical representation of the one or more stored modified processes including a plurality of nodes representing steps performed to execute the one or more stored modified processes, and
an effect of each node of the one or more stored modified processes that is different from a node of a corresponding base process is associated in memory with the respective node of the one or more stored modified processes.

8. The method of claim 1, wherein suggesting, by the processor, the at least one of the one or more stored modified processes includes ranking the at least one of the one or more stored modified processes based on a similarity of the one or more effects to the at least one desired effect, and based on a similarity of the one or more stored modified processes to the base process.
